(19) United States
(12) Patent Application Publication
(10) Pub. No.: US 2024/0090392 A1
(43) Pub. Date: Mar. 21, 2024

(54) METHOD OF CULTIVATING PLANTS AND SYSTEM THEREFOR

(71) Applicant: PRIVA HOLDING B.V., De Lier (NL)

(72) Inventor: Petrus Gerardus Hendrikus KAMP, Amersfoort (NL)

(21) Appl. No.: 17/768,809

(22) PCT Filed: Oct. 14, 2020
(86) PCT No.: PCT/NL2020/050634

§ 371 Date: Apr. 13, 2022

(30) Foreign Application Priority Data
Oct. 15, 2019 (NL) 2024022

(51) Int. Cl. A01G 25/16

(52) U.S. Cl. CPC A01G 25/16

(57) ABSTRACT

A method of cultivating plants in which a quantity of one or more consumables that is fed to the plants at a given time is controlled based on a prediction of a capacity of consumption of said plants at a time in the future relative to the given time using a function of capacity of consumption for said plants that varies over time, and is compensated for a difference between an indication of real consumption of said plants at a time in the past relative to the given time and a theoretical capacity of consumption of said plants determined for said time in the past using said function.

### FIELD OF THE INVENTION

The present invention relates to a method of cultivating plants, in which the flow of water and/or CO₂ to the plants, and/or light incident on the plants is controlled based on measurements which indicate a change one or more flow parameters which are indicative of water uptake by the plants and/or transpiration by the plants. Examples of such flow parameters include air flow along the plants which affects transpiration by the plants, water flow to and/or through the plants which affects water uptake by the plants, and light energy incident on the plants which affects the transpiration by the plants.

The invention further relates to a system including a greenhouse and a control apparatus adapted for carrying out the method.

### BACKGROUND OF THE INVENTION

When plants are cultivated in a greenhouse in which a climate system is provided it is common practice to monitor environmental parameters within the greenhouse such as temperature, CO₂ concentration and air humidity in the greenhouse. As soon as one or more of these environmental parameters exceeds a pre-set bound (or “set point”), the climate system is operated to alter the conditions in the greenhouse until the value of the environmental parameter is again within acceptable bounds. For instance, a pre-set maximum temperature within the greenhouse may be set to 20° C., and the climate system may be adapted to open vents of the greenhouse as soon as this temperature is exceeded, in order to allow exchange of hot air inside the greenhouse with cooler air from outside the greenhouse. More advanced conventional climate systems allow the pre-set bounds which have different values at different times of day. For instance, during the night the maximum acceptable temperature within the greenhouse may be lower than during the day.

An improvement to this conventional manner of cultivating plants is described in WO 2010/087699 A1. From this International patent application a method and system are known for controlling the climate in a space in which an organism, such as a plant, is accommodated. The known method comprises first measuring the temperature of the plant at two different height levels as well as a change in speed in vertical direction of air surrounding the organism, and based on these measurements the climate for the plant may be controlled.

Though this known method has resulted in improved control of climate for plants, which may improve plant yield, there is still a desire to provide the plants with an optimal amount of consumables, in particular water, nutrients CO₂ and/or light, at the right time, to optimise the yield, and to make more efficient use of resources of consumables, in particular water, needed for growing plants. It is an object of the present invention to provide a method and system for at least partially make efficient use of consumables supplied to the plant in a cultivation system, such as a greenhouse or open field. Alternatively or additionally, it is an object of the present invention to provide a method and system for at least partially improving plant yield in a plant cultivation system, such as a greenhouse or an open field.

### SUMMARY OF THE INVENTION

To this end, according to a first aspect, the invention provides a method that can be described as a method of cultivating plants in which a quantity of one or more consumables that is fed to the plants at a given time is controlled based on a prediction of a capacity of consumption of said plants at a time in the future relative to the given time using a function of capacity of consumption for said plants that varies over time, and is compensated for a difference between an indication of real consumption of said plants at a time in the past relative to the given time and a theoretical capacity of consumption of said plants determined for said time in the past using said function. The consumables are provided to the plants in a controlled quantity to allow the plants to grow and develop by consuming the consumables. The consumables for example include water, nutrients, light and CO₂. Adapting the amount of consumables that are fed to the plants at a given time to a future consumption capacity of the plant, allows the plants to optimally grow and develop, and enables efficient use of resources of the consumables. By compensating for a discrepancy between an indication of real consumption of the pant and the function of capacity of consumption, an accurate prediction of the future consumption can be obtained. This way, the plants can for instance be provided with a quantity of water that is appropriate for the plants' activity, thereby preventing an excess or deficit that is suboptimal for the plants' growth and development. It will be appreciated that the given time may be a time interval or a moment in time, e.g. a current point in time. It will also be appreciated that a plant includes both an underground portion, e.g. roots, and micro-organisms associated therewith, and an overground portion, e.g. shoots, stem, leafs, fruits.

An indication of real consumption of the plants can be obtained by measuring, either directly or indirectly, one or more flow parameters of the plants over a period of time, e.g. 90 minutes, prior to the given time. The measured flow parameters, or a change of flow parameters over the period of time, may for example be indicative of a real consumption of the plant, such as the real water uptake and/or transpiration of the plant.

A prediction of a capacity of consumption of the plants in the future, may include predicting a change in water uptake and/or water transpiration by the plants at one or more future points in time which are ahead of the give time. The prediction can be based on a measured indication of change of one or more flow parameters.

The consumption capacity, i.e. a capability of the plant to consume, of a particular consumable by the plants can vary as a function of time. For example, the consumption capacity of water by the plants can vary during a time scale of day, but also during a time scale of an hour, a week, a month, a season, and/or one or more years. Such time variation of consumption capacity of the plants can be an intrinsic attribute of the plants that may be linked to natural cycles, such as a day-night cycle and the cyclic course of the seasons. The consumption capacity over time may also differ between various consumables and between various plant varieties. The function of consumption capacity of consumables by the plants over time may be experimentally and/or theoretically determined. Said function of consumption capacity of consumables by the plants over time may be compensated for particular environmental circumstances of the plants that have occurred or that are expected to occur, such as heavy rain fall in an open field. It will be appreciated that consumption of a consumable includes for instance the processing, storage, assimilation and/or retention of the consumable.

In an embodiment, said given time accounts for a time delay between a time of feeding consumables to the plants and consumption of said consumables by said plants at said future point in time. There may be a time delay between the time at which the consumable is fed to the plants and the time at which the plants are able to consumes the consumable. For example, there may be a time delay between a supply of water to the substrate in which the plants grow, and the time at which the plants uptake the water from the substrate, stores the water, and/or transpires the water. The given time at which the controlled quantity of consumable is fed to the plants could thus be determined so as to anticipate for said time delay.

In an embodiment, said function of capacity of consumption for said plants include at least one cyclic component, e.g. a circadian cycle component for said plant, a growth cycle component for said plants and/or developmental cycle component for said plant. From the function of consumption capacity over time, a pattern may be extracted, indicating the cyclic component. The cyclic component may be linked to natural cycles of the environment of the plant, such as a day-night cycle and the cyclic course of the seasons. The consumption capacity of the plants may be dictated by the cyclic component of the plant, e.g. by the circadian cycle component. A consumable may be fed to the plants at a regular time interval, based on the at least one cyclic component. For instance, the plants may be supplied with a quantity of water daily, weekly or monthly, at a fixed time of the day. The plants may e.g. be fed with a quantity of water daily, wherein the feeding moment is within the same hour for every day.

In an embodiment, consumption of said plants is expressed using at least one water related parameter of said plant, in particular water transpiration, water take up, water retention, a water balance and/or water drain for said plants and/or their substrate.

In an embodiment, said indication of real consumption of said plants include a determination of at least one water related parameter of the plants, in particular water evaporation, water take up, water retention, a water balance and/or water drain for said plants and/or a substrate the plants are cultivated on.

In an embodiment, the controlled consumables include water.

In an embodiment, the controlled consumables are water, optionally water enriched with nutrients. Particularly in open field cultivation, water supply to the plants in the open field is one of the few consumable feeds to control.

In an embodiment, the plants are cultivated in an open field.

In an embodiment, a substrate that the plants are cultivated on includes or is soil.

In accordance with the first aspect, the present invention provides a method of cultivating plants, comprising the steps of: obtaining measurements which indicate a change in one or more flow parameters of the plants over a period of time within 90 minutes prior to a current point in time, the flow parameters being indicative of transpiration by the plants, and/or water uptake by the plants; predicting a change in water uptake and/or water transpiration by the plants at one or more future points in time which are ahead of the current point in time, based on the measured indication of change of the one or more flow parameters; and prior to said one or more future points in time: controlling one or more of: flow of water to the plants, flow of CO₂ to the plants and/or light incident on the plants, based on the predicted change in water uptake by the plants and/or water transpiration by the plants at the one or more future points in time and substantially compensating for a delay of between 5 to 30 minutes between a change in transpiration by the plants and a corresponding change in water uptake by the plants.

Thus, based on a change in one or more of the flow parameters that occurred within 90 minutes of the current time, a change in water uptake and/or water transpiration by the plants at future points in time can be predicted, and based on the predicted change, for instance the flow rate of water to the plants can be controlled to compensate for a delay between 5 and 30 minutes. In this manner the method of the invention takes into account the fact that the change in rate of transpiration by the plants typically lags behind the change in rate of water uptake by between 5 and 30 minutes, and according to the method the flow of water to the plants is controlled in a way in which the actual water content of the plants can be kept substantially stable, in particular more stable than in prior art systems in which climate control devices are operated to act as soon as a measured temperature falls outside of pre-set bounds.

For instance, based on the measured indication of change in air flow along the plants, which affects the plants' transpiration, it is possible to predict how this change in air flow will affect the water transpiration and/or water uptake by the plants at future points in time, assuming other conditions for the plants remain substantially the same. The flow of water provided to the plants at the current point in time can then be controlled such that this flow of water varies smoothly in time, taking into account that the plant's reaction to any adjustment of the flow of water to the plant will be delayed by between 5 to 30 minutes. The resulting water flow to the plants, in particular in the root zone of the plants, will thus vary smoothly, rather than oscillate frequently, and the plants only have to respond to relatively smooth changes in water flow to the plants. Water flow to the plants can typically be controlled regardless of whether the plants are located within a greenhouse, or are located outside, e.g. in a field.

Within a greenhouse, flow of CO₂ can be controlled to vary smoothly, e.g. by controlling CO₂ exchange within the greenhouse to vary smoothly by controlling venting of air from inside the greenhouse to the exterior to occur gradually, in particular according to a smooth curve, and/or by controlling a CO₂ generator unit within the greenhouse to gradually add CO₂ to the air in the greenhouse, rather than suddenly.

In prior art methods in which the flow of water to plants is controlled, the flow of water to the plants is typically controlled by measuring a current indication of water uptake by the plants and immediately adjusting flow of water to the plants based on a difference between the current indication and a current set point value. For instance, in the prior art if a first, current measurement indicates that the water uptake for a bed of plants is 1 litre/min, whereas the current set point value is 1,2 litre/min, then the flow of water to the plants would be increased until further measurements indicate that the water intake corresponds to the set point value for that point in time. However, at the time at which the flow of water to the plants is first increased, the plants need still need some time, typically between 5 and 30 minutes, to adjust to the increased flow, and consequently an excess of water will be supplied to the plants for about the same amount of time. Likewise, once the flow of water to the plants is substantially equal to the set point value, the plants may continue to increase their water uptake for some time. If the current measurement of the water uptake indicates the set point has been exceeded, the flow of water to the plants will subsequently be decreased until the desired set point has been reached. At that time the plants may continue to lower their water intake, so that the flow of water to the plants has to be increased again, and so on.

The actual water uptake by the plants thus will lag behind a change in the water flow to the plants. This may result in undesirable fluctuations in the actual water uptake. If the actual water uptake by the plants were graphed vs. time, e.g. at intervals of 0.5 min, this would result in a line with many peaks and valleys within a short time interval, such as an interval of an hour, rather than a substantially smooth line. The plants would thus have to cope with many changes in water uptake conditions in the short time interval, which hinders the plant's development.

The method of the invention at least partially overcomes this problem by taking the delay between a change in transpiration by the plants and a corresponding change in water uptake by the plants into account, thus reducing the frequency and magnitude of changes the plants have to deal with. The exact delay that is compensated for depends on the plants used and specific circumstances in which the plants are cultivated. The skilled person will be able to estimate a value for the delay, e.g. by changing the flow of water from a first setting to a second setting, and measuring how long it takes the plants to change their rate of transpiration correspondingly, and in many cases the delay may be a predetermined delay that is known for the plants in the conditions in which they are grown before any of the steps of the method of the invention are carried out. Alternatively, the duration of the delay could be estimated by changing the flow of water from a first setting to a second setting, and measuring how long it takes for the water uptake of the plants to change correspondingly. A plant's water uptake may for instance be calculated as the amount water supplied to the substrate in which the plant is planted, minus the amount of water drained from the substrate. Of the water taken up by the plant, a portion is evaporated by the plant during growth as transpiration, while another portion is retained by the plant, adding to its mass.

By taking the delay into account, the method allows pre-steering of flow of water and/or CO₂ to the plants, and/or of light incident on the plants. Rather than responding instantaneously to a difference between a set point, for instance for air humidity, temperature, and a current value thereof the method predicts how water uptake and/or water transpiration by the plants would be changed at the future points in time, and controls flow of water to the plants, flow of CO₂ to the plants and/or light incident on the plants to take this predicted change into account.

Factors which are indicative for a change in transpiration by the plants and/or water uptake by the plants, include one or a combination of any of: air flow along the plants, air humidity, CO₂ concentration and temperature of air in the space in which the plants are grown and/or leaf temperature of the plants.

Preferably, when the supply of water to the plants is controlled, nutrients are added or have been added to the supply of water before the water reaches the plants.

In an embodiment, some or all of the future points in time lie within 2 hours of the current point in time. The method can thus predict at change in water uptake and or transpiration by the plants for said points, and the method can be repeated to adapt to changing circumstances.

In an embodiment the method is repeated at least once every hour, preferably at least once every 30 minutes. his also allows the method to adapt to changing circumstances.

In an embodiment the step of obtaining measurements comprises obtaining, over said period of time within 90 minutes prior to the current point in time, first measurements which indicate a change in a first flow parameter indicative of transpiration by the plants, and second measurements which indicate a change in a second flow parameter indicative of water uptake by the plants; and wherein said delay is determined by comparing the first measurements with the second measurements and determining by how much a change in the first flow parameters lags to a change in the second flow parameters. According to this embodiment, the delay can be determined as the method is being carried out, and in case the delay changes during the day, it can be adjusted accordingly during the day.

In an alternative embodiment, the delay is a predetermined delay that has been determined prior to carrying out the method. For instance, the delay may be determined a day prior to the day on which the method is carried out. The predetermined delay may be constant during the day, but preferably is a function of time of day which has values between 5 and 30 minutes.

In an embodiment in the step of controlling, only or at least the flow of water to the plants is controlled based on the predicted change in water uptake by the plants and/or water transpiration by the plants at the one or more future points in time while substantially compensating for the delay between the change in transpiration by the plants and the corresponding change in water uptake by the plants. Generally, regardless of whether the method is carried out in a greenhouse or in an open field, the flow of water to the plants can be controlled, while transpiration by the plants may not be so easily controlled when the plants are grown in a field.

In an embodiment the step of controlling is carried out prior to the closest future point in time by an amount of time substantially equal to the delay.

In an embodiment the flow of water to the plants, flow of CO₂ to the plants and/or light incident on the plants, is controlled to vary substantially smoothly over time. When the flow of water and/or CO₂ to the plants, and/or the light incident on the plants changes smoothly, rather than suddenly, the plants do not have to cope with sudden changes. In this example, the flow of water and/or CO₂ to the plants may be said vary smoothly over time if, at any point during said time, the flow of water and/or CO₂ deviates no more than +-5% from a predetermined non-linear spline having between 8 and 3 control points, preferably a non-linear spline having 5 or 4 control points, such as a parabolic or cubic spline. This spline may correspond to a predetermined smooth curve as described below, which has been stretched or compressed and/or shifted to best fit a graph of one of the flow of water to the plants, the flow of CO₂ to the plants, and light incident on the plants.

In an embodiment the change in water uptake by the plants and/or water transpiration by the plants for the one or more future points in time is predicted further based on a predetermined continuous smooth curve which spans a period of time of at least 8, hours, preferably at least 12 or at least 24 hours, and which includes the one or more future points in time. This results the flow of water, CO₂ and or light incident on the plants being controlled to vary smoothly over time as well.

In an embodiment the predetermined curve is a curve which, at any position, deviates no more than +-5% from a non-linear spline having between 8 and 3 control points, preferably a non-linear spline having 5 or 4 control points. According to this embodiment, the predetermined curve can be considered to be smooth if it deviates relatively little from such a non-linear spline. Preferably, the curve is a parabolic or cubic spline with between 8 and 3 control points. Splines are continuous and smooth, and thus allow smooth control of climate control devices, such as a window with a controllable degree of opening, a ventilator, a water supply, an adjustable cloth screen, a CO₂ supply, and so on, without resulting in significant oscillations in the transpiration by the plants.

In an embodiment, the step of controlling the flow of air along the plants, the flow of water through the plants and/or light incident on the plants comprises controlling a climate control device to operate along a substantially smooth control curve wherein said smooth control curve corresponds to the predetermined curve which is stretched or compressed along time based on the measured indications. Stretching or compression is preferably such that the time of the highest point of the smooth control curve corresponds to the time of the highest point of the predetermined curve. The control curve may be used to control the climate control devices, e.g. to control a degree of opening of a window, to control the degree to which a cloth screen blocks sunlight to the plants, to control a degree to which humidity is present in the air in the interior space and so on. The measured indication of the previous change in air flow along the plants and/or water flow through the plants, may be used to adjust the control curve based on previously measured values. Generally, three or more measurements of such a change suffice to adjust the control curve. The method of this embodiment thus substantially prevents that climate control devices are operated in such a manner that they cause the water content of the plants to change in a rapidly oscillating manner. For instance, if a window of a greenhouse is controlled in correspondence with a smooth control curve, then the degree of opening of the window will vary smoothly over time. Likewise, if a water supply is controlled in correspondence with the smooth control curve, then the water supply rate to the plants will vary only smoothly over time. If the flow of air along the plants is controlled in correspondence with the smooth control curve, then this flow will also vary smoothly over time, rather than oscillate frequently. The control curve preferably has no more than one peak or valley within each 1-hour segment of the control curve.

In an embodiment the predetermined curve represents a predetermined circadian rhythm of the plants over said at least 8 hours, preferably at least 24 hours, wherein said at least 8 hours include a time period of at least 4 hours during which the plants are in the dark. Herein, the plants are defined to be in the dark when the light incident on a horizontal surface at the level of the plants and in the wavelengths between 400 nm and 700 nm has an energy of less than 30 Watt/m². It has been found that if the amount of water evaporated by the plant as transpiration is kept substantially proportional to the plant's circadian rhythm, this results in an increased amount of water retained by the plant, and thus also in increased plant mass. The invention allows the water supply to the plants to be controlled in such a manner that only little of the water supplied to the plants is drained again through the substrate, and such that the plants still retains a portion of the water supplied thereto without being subjected to insufficient or excess amounts of water for longer amounts of time.

By adjusting the supply of water to the plants based on their circadian rhythm, the plants can be provided with their desired amount as they need it or just before they need it. In this manner, the amount of time the plants experience a shortage or excess of water can be reduced. In contrast, in the prior art, only once it has been detected that a plant receives insufficient water, the flow of water to the plant may be increased to resolve this. The present invention makes use of the fact that a plant's water requirements may be predicted to a large extent based on the plant's circadian rhythm, allowing adjustment of the flow of water to the plant before it experiences a significant shortage or excess of water. The inventor has further found that when the adjustment of the flow of water to the plants is based on the rate of change in plant's water intake, light intake and/or air flow across the plant's, then the plant's internal water content may be kept more stable over time than if the adjustment of the flow of water is based only on absolute values of water intake, light intake and/or air flow across the plants.

In an embodiment the circadian rhythm is selected from a predetermined circadian rhythm of the plants with respect to one or more of: uptake and release of CO₂ by the plants, uptake of water by the plants and transpiration of water by the plants, and/or generation of sugar by the plants. The predetermined circadian rhythm of the plants is generally determined under conditions which vary from the actual current conditions. For instance, the predetermined circadian rhythm may represent the circadian rhythm of the plants as determined earlier during cloudless conditions in the summer, whereas at the current time it is winter. In order to compensate for differences in conditions, the curve may be adjusted by stretching or compressing the curve with respect to time. It has been found that based on a same curve, the flow of water, CO₂ and or light incident on the plants, can be controlled to vary smoothly, regardless of whether it is summer or winter.

In an embodiment the spline has at most one point of inflexion in each time period of the curve spanning 2 hours, preferably 3 hours. That is, within each span of 2 hours of the spline, there is at most one peak or one valley.

In an embodiment, the predetermined curve, at least during a duration of time during which the light energy incident on the plants is 30 Watt/m² or greater, corresponds to a polynomial function of time, wherein the polynomial function is of the 4th or greater degree. The highest peak of this polynomial function will generally occur the time at which the sun has reached its highest position.

In an embodiment the step of obtaining measurements comprises obtaining at least three such measurements in order to determine the delay for to compensate when controlling said flow of water to the plants, flow of CO₂ to the plants and/or light incident on the plants.

In an embodiment the duration of the delay varies over said time period of at least 8 hours. That is, the delay is not a constant amount of time over the at least 8 hours. When at least three measurements are taken, as described with reference to the previous embodiment, the variation in delay can be calculated and compensated for. For instance, for tomatoes it has been found that the delay increases with distance to the highest point on the curve. If for tomatoes the highest point of the curve is at 12 h30, then at that point the delay that is to be compensated for would be minimal, e.g. 5 minutes, whereas at 8 h00 or 1800 the delay that is to be compensated for is about 20 minutes. For some other plants it has been found that the delay is highest at first light (i.e. immediately after it is no longer dark) and decreases towards the evening (i.e. when in becomes dark). Preferably the duration of the delay varies by at least 5 minutes over a time period of at least 4 hours in which the plants are not in the dark.

In an embodiment the method is carried out in a greenhouse having an interior space for cultivating plants. Typically several climate factors can be controlled in a greenhouse. For instance the temperature, humidity and/or CO₂ concentration of the air of the interior space can usually be decreased by venting air e.g. by operating a ventilator and/or controlling a degree of opening of windows. The air temperature in a greenhouse can usually be increased by operating heating means to supply heat energy to the interior, e.g. by providing heated air to the interior, by electrically heating the air and/or by burning fossil fuel in the interior space. Air humidity may be increased by providing more humid air to the interior space and/or by spraying or atomizing water in the greenhouse, and CO₂ concentration in the greenhouse can be increased by operating a CO₂ generator or CO₂ supply device in the greenhouse. Many climate control devices for controlling these factors in a greenhouse will be known to the person skilled in the art. By controlling these devices in accordance with the method of the invention, it can be ensured that the plants have to deal with fewer and smaller oscillations in environmental conditions.

In an embodiment the flow of water to the plants is controlled substantially independent of a measured temperature of the air in the interior space as long as the measured temperature of the plants is in the range of 4 to 41,6° C. measured at 1 atm. The temperature of the plants themselves may be measured by measuring the temperature of a cell, root, or shoot of a plant, preferably by contacting a shoot meristem of the plant. The method of the invention thus can be carried out free from preset target temperatures for the air surrounding the plants; as long as the rate of transpiration is substantially constant, the plant temperature may be between 4 and 41.6° C., making the method particularly suitable for use in environments in which control of temperature is not possible or difficult, e.g. in open field, and in which the rate of transpiration by the plants can be controlled to some extent by controlling the rate of supply of water to the plants.

In an embodiment the air humidity in the interior space is controlled to be at least 5 g water per kg of air, and/or the CO₂ concentration of the air in the interior space is controlled to be above 185 ppm. Other than the bounds for temperature, and the lower bounds for humidity and/or CO₂ concentration, the method can be carried out without using any set points for temperature, humidity and/or CO₂ of the air surrounding the plants.

In an embodiment the flow of water to the plants is controlled in such a manner that, at the one or more future points in time, a rate of transpiration by plants is within +-5% of a rate of water uptake by the plants. As the flow of water to the plants is controlled such that rate of transpiration of the plants is close to the rate of water uptake by the plants, the total amount of water in the plants varies gradually, rather than oscillating quickly.

In an embodiment the method further comprises a prior step of measuring an estimate of the circadian rhythm of the plants during a time period of at least 24 hours and generating the predetermined curve from said estimate.

According to a second aspect the invention provides a method of cultivating plants, comprising the steps of:
based on measurements that are indicative of a previous change in transpiration by the plants and/or based on measurements that are indicative of a previous change in water uptake by the plants, predicting a change in water uptake and/or water transpiration by the plants at one or more future points in time which are ahead of the current point in time; and
prior to the one or more future points in time: controlling one or more of: flow of water to the plants, flow of CO₂ to the plants and/or light incident on the plants, based on a predetermined smooth curve and/or and the predicted change in water uptake or water transpiration by the plants, in such a manner that a delay of between 5 to 30 minutes between a change in water uptake and a corresponding change in transpiration by the plants is substantially compensated for. Thus, the method takes into account the delay of between 5 and 30 minutes there is from the moment the flow of water or CO₂ and or light incident on the plants is controlled, to the moment the plants have correspondingly adjusted their water uptake and transpiration. Preferably, the flow of water to the plants, the flow of CO₂ to the plants and/or the light incident on the plants is controlled to vary in correspondence with the predetermined curve. The predetermined curve may be a predetermined curve as described herein in relation to the first aspect of the invention.

The measurements based on which the change in water transpiration and/or water uptake by the plants is predicted, are all preferably all carried out within 90 minutes from the time the one or more of: flow of water to the plants, flow of CO₂ to the plants and/or light incident on the plants are controlled.

The embodiments of the method according to the first aspect also apply to the second aspect of the invention.

In an embodiment, the one or more of the flow of water to the plants, flow of CO₂ to the plants and/or light incident on the plants, are controlled such that the flow of water to the plants, flow of CO₂ to the plans and/or light incident on the plants substantially follows a smooth control curve over time, wherein said smooth control curve corresponds to the predetermined curve which is stretched or compressed along time based on the measured indications. Stretching or compression is preferably such that the time of the highest point of the smooth control curve corresponds to the time of the highest point of the predetermined curve. The control curve may be used to control one or more climate control devices, e.g. to control a degree of opening of a window, to control the degree to which a cloth screen blocks sunlight to the plants, to control a degree to which humidity is present in the air in the interior space and so on. The measured indication of the previous change in air flow along the plants and/or water flow through the plants, may be used adjust the control curve based on previously measured values. Generally, three or more measurements of such a change suffice to adjust the control curve.

According to a third aspect the invention provides a system comprising: a greenhouse or open field for cultivation of plants, comprising one or more consumable feed devices for feeding one or more consumables to the plants, and a control apparatus connected to said one or more consumable feed devices and configured for controlling said one or more consumable feed devices according to the method as described herein. The greenhouse may comprise a housing which defines an interior space, and one or more climate control devices for controlling one or more of: temperature, CO₂ concentration and/or humidity of the air in the interior space and supply of water to the plants; wherein the control apparatus is connected to said one or more climate control devices and configured for controlling said climate control devices according to the method of the invention. It will be appreciated that the term greenhouse used herein, refers to any system where plants are cultivated substantially indoors, irrespective of a light source used for cultivation. It will also be appreciated that the term open field refers to systems where plants are cultivated substantially outdoors.

According to a fourth aspect, the invention provides a computer readable medium provided with instructions thereon, which, when executed by a computer, cause the computer to carry out the method according to the first aspect of the invention.

According to a fifth aspect, the invention provides a plant or plant product, e.g. fruits, seeds, flowers, tubers, leaves, of a plant, obtained or obtainable by a cultivation method as described herein. More particular, the fifth aspect relates to a plant that is cultivated using control data that is obtained according to a cultivation method as described herein.

According to a sixth aspect, the invention provides a set of control data for use in a method of cultivating plants in which a quantity of one or more consumables that is fed to the plants at a given time is controlled using said data, the data being obtained based on a prediction of a capacity of consumption of said plants at a time in the future relative to the given time using a function of capacity of consumption for said plants that varies over time, and having been compensated for a difference between an indication of real consumption of said plants at a time in the past relative to the given time and a theoretical capacity of consumption of said plants determined for said time in the past using said function.

### SHORT DESCRIPTION OF DRAWINGS

The present invention will be discussed in more detail below, with reference to the attached drawings, in which

FIGS. 1A-1C respectively show schematical diagrams of prior art greenhouses with climate control devices;

FIGS. 2A and 2B respectively show a graph of a control signal for a climate control device according to a method of the prior art, and according to the method of present invention;

FIGS. 3A and 3B illustrate the effect of different amounts of sunlight on plant transpiration, and how this can be adjusted for according to the invention;

FIGS. 4A-4C show further examples of the effect of different amounts on plant transpiration;

FIGS. 5A and 5B illustrate how the method of the invention may be carried out;

FIGS. 6A and 6B illustrate how the method of the invention may be carried out in an open field.

### DESCRIPTION OF EMBODIMENTS

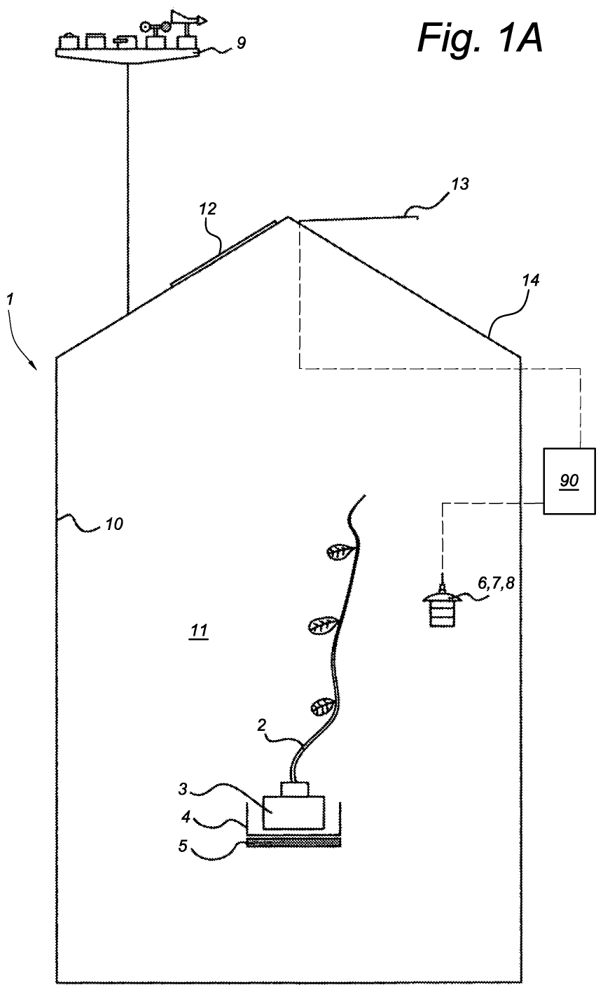

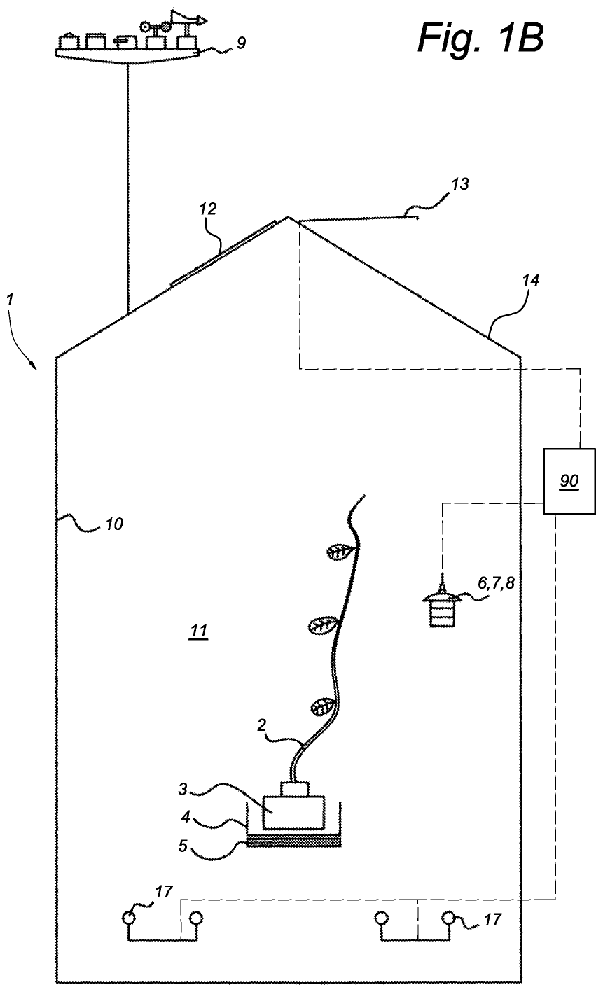

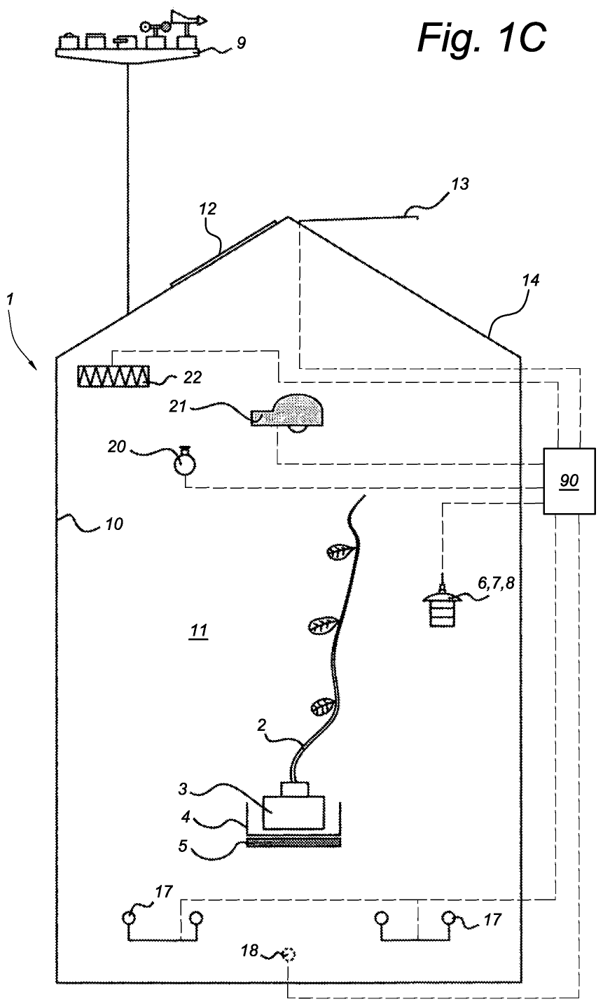

FIG. 1A schematically shows a prior art greenhouse 1 as may be used with the present invention. The greenhouse 1 comprises a housing 10 which defines an interior space 11 for cultivation of plants 2, in particular green leafed plants. The roof of the housing is provided with windows 12, 13, of which window 13 can be hinged relative to the roof 14 using an actuator (not shown) attached to both the roof and the window 13, so that the windows 13 can be moved between an open and a closed position. A control-apparatus 90 is connected to the window 13 and arranged for controlling the actuator to move the window 13 between the open and closed position and any intermediate position is desired. The plants 2 have roots in a substrate 3 which is arranged on a substrate gutter 4. To facilitate determining a measure of gain in weight of the plants and substrate to be determined, the substrate gutter 4 is arranged on a weight sensor 5. The weight sensor 5, together with the gutter 4 is supported on a table or the like (not shown), so that the substrate and plants are spaced apart from the floor of the greenhouse 1. Temperature and humidity of the air within the space 11 is measured respectively by air temperature sensor 6 and air humidity sensor 7, and CO₂ concentration of the air in the space 11 is measured using CO₂ sensor 8. Air temperature, humidity and wind speed outside of the greenhouse may be measured by a weather station 9 provided on the roof 14.

Depending on the degree to which the window 13 is opened, air from within the housing 10 can be exchanged with air from outside the housing 10 in order to adjust a temperature, air humidity and/or a CO₂ concentration within the space 11.

FIG. 1B shows the greenhouse 1 of FIG. 1A, additionally comprising heating tubes 17 arranged at a lower side of the plants 2. The heating tubes are arranged for providing heated air to the space 11, as needed, and like the window 13 are controlled by control apparatus 90.

FIG. 1C shows the greenhouse of FIG. 1B, provided with further climate control devices.

A CO₂ supply tube 18 is arranged at a lower side of the plants 2 and adapted for provide CO₂ to the interior space 11 to promote plant growth. The greenhouse of FIG. 1C further comprises a screening arrangement 22 which comprises a screening cloth that can be in a substantially retracted position, as shown, in which the cloth substantially does not block sunlight that passes from through the roof from directly reaching the plants, and an extended position in which the screening cloth spans across the roof and substantially blocks light that passes through the roof 14 from directly reaching the plants 2. Further shown are grow lamps 21 for emitting light on the plants, and a water atomizer 20, for increasing the air humidity in the space 11, all connected to and controlled by the control apparatus 90.

In the greenhouses of FIGS. 1A-1C, climate factors such as temperature, air humidity, and CO₂ content in the space 12 can be controlled to some extent by the control-apparatus 90, by operating the window 13 to open or close, operating the screening cloth to block sunlight from reaching the plants to some degree, controlling supply of heated air through the heating tubes 17, controlling supply of CO₂ via the CO₂ supply tube 18, etc. in known fashion.

These prior art greenhouses have in common that climate control devices are provided which can be operated to control the climate in the greenhouse to some extent.

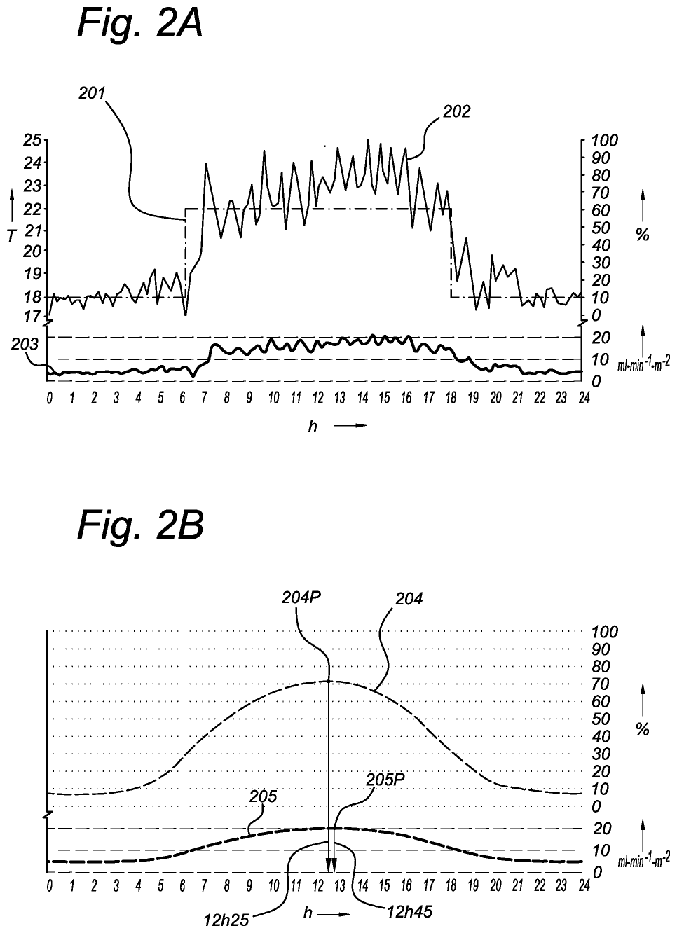

FIG. 2A illustrates how the temperature in the space 11 would be controlled using the conventional greenhouse illustrated in FIG. 1A which has a window 13 that can opened to a degree in order to vent heated air from the interior space 11 to outside the greenhouse and draw in cooler air. Dotted line 201 represents a set point temperature in the greenhouse over time, which is determined in advance by the plant grower. The vertical axis on the left represents the set point, or target, temperature in the space 11, and the horizontal axis represents a period of time of 24 hours. Line 201 indicates that between 6 h00 and 18 h00 the temperature in the space 11 should be 22 C°, and between 00 h00 and 6 h00 and 18 h00 and 24 h00 the temperature in the space 11 should be 18 C°.

The temperature of the air in the interior space 11 is substantially constantly measured, e.g. at least every 6 minutes, using the temperature sensor 6. Based on a difference between the measured temperature and the set-point temperature at the current point in time, the window 13 is controlled to open or close to a degree indicated by line 202, wherein the upper right-hand axis indicates a percentage representing the extent to which the window is opened. At about 6 h20 the degree to which window is opened is 0%, i.e. the window is completely closed, and about 14 h20, the degree to which the window is opened is 100%, i.e. the window is completely open. Assuming the air outside the greenhouse is cooler that in the interior space 11, the window is opened as soon as the temperature in the space 11 exceeds the set point indicated by line 201, and the window is closed as soon as the temperature in the space falls below the set point indicated by line 201. As can be seen, the degree to which the window is open oscillates significantly, with the line 202 often having peaks and valleys within time periods of less than an hour.

The flow of hot air out of the interior space 11 and the drawing in of cooler air through the window 13 results in an air flow across the plants 2, which affects the plants' rate of transpiration. The plants' rate of transpiration, an indication of which can determined using the humidity sensor 7 in the greenhouse of FIG. 1A, is indicated by line 203. The rate of transpiration is typically measured in ml per minute per m 2 of plants, and in FIG. 2A the lower right-hand vertical axis provides a scale there for. After a change in degree of opening of the window 13, there is a lag of between 5-30 minutes before the plants adjust their rate of transpiration correspondingly. Thus, the shape of line 203 is approximately equal to the shape of line 202, but with a lag of between 5 and 30 minutes. For instance peak 202a of line 202 occurs about 20 minutes earlier than the corresponding peak 303a in line 303. Transpiration by the plants is linked to the rate of water uptake by the plants as well as to rate of dry-mass gain by the plants. As can be seen, when the climate in the greenhouse 1 is controlled based on momentaneous measurements of temperature and in turn the degree of opening of the window 13 is immediately controlled based on said measurement, then the rate of transpiration, and consequently also the rate of water uptake and the rate of dry mass gain by the plants oscillates in a similar manner as the degree of opening of the window 13.

The climate control devices 13, 17, 18, 20, 21 and 22, described with reference to FIGS. 1A-1C are mentioned as examples but do not limit the invention. Many other devices for controlling the climate in a greenhouse are known to the skilled person and could be applied to the present invention.

FIG. 2B illustrates how temperature of air in the interior space 11 is controlled according to the present invention, with again the top right hand vertical axis providing a scale for the degree of opening of the window, the lower right-hand axis providing a scale for transpiration by the plants, and the horizontal scale representing a period of time of 24 hours. According to the graph of FIG. 2B, the temperature is controlled based on a predetermined curve 204 which corresponds substantially to the curve of the circadian rhythm of water uptake or transpiration by the plants 2 over 24 hours. The curve 204 is smooth, i.e. each 1-hour section of curve has at most one peak or one valley which deviates more than 5% from a continuous cubic spline that fits through the curve 204, wherein the cubic spline has between 8 and 3 fewer control points. The curve 204 is predetermined in the sense that the curve is known before the window 13 (or possibly another climate control device), is controlled based on the curve. In FIG. 2B, curve 204 has a peak 204P at about 0 h00 and at about 12 h25, and there is a valley at about 02 h00 and 23 h00, though the peak at 0 h00 and valleys at 0200 and 23 h00 are very slight. According to the invention, temperature is controlled by opening the window to an degree based on the curve 204. This results in a correspondingly smooth change in the plants' transpiration rate indicated by line 205. Line 205 is delayed, i.e. shifted to the right, with respect to the curve 204 by between 5 and 30 minutes as indicated by line 205. Thus, if the windows 13 of the greenhouse of FIG. 1A were controlled according to the invention, then the degree of opening of the window 13 would substantially follow line 204, resulting in a rate of transpiration corresponding to line 205. Line 205 is similar to line 204 but delayed so that where line 204 has a peak at about 12 h25, line 205 has a corresponding peak 205P at about 12 h45.

As can be seen in FIG. 2B, the degree of opening of the window does not oscillate rapidly, and specifically oscillates less than in the prior art method of controlling temperature described with reference to FIG. 2A. Over the whole time period of 24 hours, the smooth curve 204 shown in FIG. 2B at most has 4 points of inflexion, and the corresponding rate of transpiration by the plants varies smoothly so that the plants do not have to cope with large changes in rate of transpiration within short periods of time. In contrast, line 202 of FIG. 2A has a multitude of points of inflexion requiring the plants 2 to adapt their rate of transpiration in a rapidly oscillating fashion. Such rapid changes result in stress for the plants, which decreases their yield.

It is noted that the momentaneous temperature measured by the temperature sensor 6 does not directly affect the degree to which the window is opened at that time, and that according to the invention, no set point for temperature over time needs to be used, other than a fixed lower bound for the temperature in the space of about 4° C., and a fixed upper bound for the temperature in the space of about 40° C. The temperature of the air in which the plants are cultivated can vary between this upper and lower bound, as long as the rate of transpiration by the plants substantially follows the line 205. As long as the rate of transpiration by the plants varies smoothly, i.e. such that each 2-hour section of a transpiration rate curve has at most one peak or one valley, the plants can grow at a steady rate without having to frequently and significantly adjust their rate of transpiration. Experiments have found that this may result in an increased yield in dry-mass of plants of up to 20% when compared to cultivating plants in a manner in which the plants' transpiration rate varies frequently, e.g. as frequently as shown in FIG. 1B.

FIGS. 2A and 2B have been described with reference to the greenhouse of FIG. 1A, which substantially only has window 13 as means for controlling the temperature in the space 11. However, the same principle holds for greenhouses having other or more means for controlling the climate in the interior space, e.g. as shown in FIGS. 1B and 1C, and even applies to plants grown in open fields outside of a greenhouse. In the latter case the method of the invention may be used to cultivate plants which grow in an open field. In such an open field the main variable that can be controlled and which affects the rate of transpiration by the plants, is the rate at which water is supplied to the plants. According to the invention, the rate of supply of water to plants in a field is gradually adjusted to substantially follow a predetermined smooth curve that corresponds to a circadian rhythm of the plants for water uptake and/or transpiration by the plants. By gradually adjusted herein is meant that if the rate of supply of water were graphed over time, the graph would be smooth and continuous, with at most one peak or one valley which deviates more than 5% from a continuous cubic spline fit through the curve 204, wherein the cubic spline has between 8 and 3 control points. The water supplied to the plants generally comprises nutrients that are dissolved in the water.

A curve representative of the circadian rhythm of water uptake and/or transpiration by the plants can be predetermined by measuring, over a period of time lasting at least 12 hours of which at least 4 contiguous hours are dark, water uptake and/or transpiration by the plants under conditions in which the light varies with the position of the sun, and during which other factors, such as water supply, CO₂ supply and supply of nutrients to the plants is substantially stable. Herein, the plants are defined to be in the dark when the light incident on a horizontal surface at the level of the plants and in the wavelengths between 400 nm and 700 nm has an energy of less than 30 Watt/m². The resulting smooth curve of the circadian rhythm will generally follow the intensity of light emitted by the sun on an area of 1 m² at the level of the plants 2.

As another example, if the method is used to control the climate in a greenhouse of FIG. 1B, then a rate of air flow from the heating tubes 17 into the space 11, and/or a degree of opening of the window 13 can be controlled according to such a smooth curve in order to prevent the rate of transpiration from oscillating rapidly, i.e. with more than one peak or valley within any 2-hour period of time. Here again, according to the invention, instead of reacting instantaneously to the measured temperature in the space 11, the climate in the space is controlled such that the rate of transpiration by the plants 2 varies smoothly rather oscillating rapidly. It will be appreciated that some minor oscillations in transpiration by the plants may occur. However, if the curve 204 can compressed or extended and shifted to substantially fit the line 205, then line 205 can be said to be smooth if at any point in time the transpiration by the plants deviates by no more than +-5% from such a fitted curve.

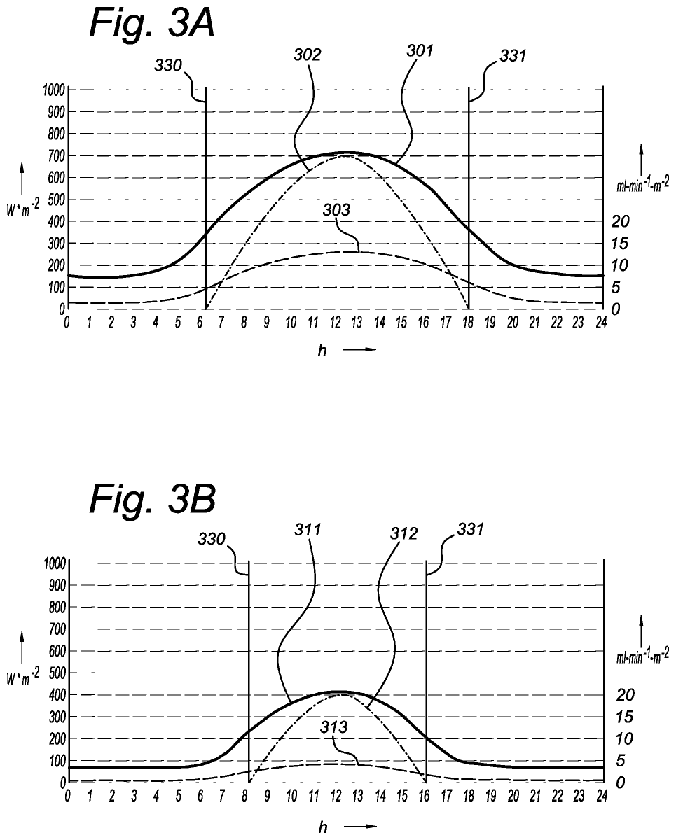

Though the shape of smooth predetermined curve is predetermined, in some cases it is desirable to adjust the curve based on the month of the year, season, or other factors which significantly affect average amount of light emitted by the sun on the plants during a day. Two examples of how a predetermined curve may be adjusted are shown in FIGS. 3A and 3B, wherein FIG. 3A shows a predetermined curve that is based 204 of FIG. 2B adjusted for spring, and FIG. 3B shows another predetermined curve based on curve 204 adjusted for winter.

FIG. 3A shows a smooth curve 301 that is based on the predetermined curve 204 from FIG. 2B adjusted by vertically stretching the curve 204 in order to take energy of sunlight incident on the plants during the spring in the Netherlands into account. The rate of transpiration by the plants is indicated by line 303 which follows the scale on the right-hand side vertical axis. Line 302 is a graph representing energy of light incident on a horizontal surface at the level of the plants and in the wavelengths between 400 nm and 700 nm.

The left-hand side vertical axis provides a scale of this energy in Watt/m². In FIG. 3A the line 302 was measured during on a spring day in the Netherlands. As can be seen, during this spring day, light from the sun was incident on the plants over a period of about 12 hours between 6 h12 (indicated by vertical line 330) and 18 h00 (indicated by vertical line 331). The area below line 302 is representative of the total amount of energy that can be used by the plants for photosynthesis during the day. Based on line 302 and on predetermined curve 204, the line 301 has been determined by vertically stretching the curve 204 to account for the activity of the sun during the summer, such that the windows or the like are opened to a larger extent for a longer period of time than compared to the situation in FIG. 3B. This results in increased transpiration by the plants, as well as increased water uptake and dry-mass gain by the plants.

FIG. 3B shows a smooth curve 311 based on the predetermined curve 204 from FIG. 2B, adjusted to take energy of sunlight incident on the plants during the winter into account. During the winter, the duration of time in which sunlight is incident on the plants is significantly (indicated by lines 330 and 331) shorter than in the spring, and the total energy incident on the plants is considerably less than in the spring as well as summer. This can be seen from line 312 which represents the energy of light incident on a horizontal surface at the level of the plants. In view of the more narrow period of time during which sunlight will be incident on the plants, the smooth curve has determined by compressing the curve 204 horizontally as well as vertically. When the window 13 is controlled according to the adjusted curve 311, the rate of transpiration by the plants is also less than in the summer.

For open field cultivation of plants, where the main parameter for the plants that can be controlled by a grower is water supply to the plants, a curve representative of the circadian rhythm of water uptake and/or transpiration by the plants can for example be predetermined. Several flow parameters can be measured in open field cultivation, including properties of the water supply to the plant, optionally enriched with nutrients, properties of the water drainage from the plant, as well as properties of the plant and substrate can be measured to determine a circadian rhythm of water uptake and/or transpiration by the plant.

For example, the time and quantity of water supplied to a plant, as well as the time and quantity of drain from the plant can be measured. Moreover, a weight of the plant including or excluding substrate, can be measured. Further, acidity (pH) and salt concentration of the substrate can be measured. Also, acidity (pH) and salt concentration of water supply and/or water drainage can be measured. In addition, energy of sunlight incident on the plant may be measured. Measurements are preferably performed over time, preferably at least three times per 24 hours, to be able to fit an appropriate circadian curve, e.g. a fourth order polynomial. It will be appreciated that any type of measurement may be combined. The obtained circadian curve can be used to as the function on which a capacity of water consumption of the plant at a future time is predicted.

In an exemplary method, the amount of water supply to a plant as well as the amount of water drainage from the plant is measured. A difference between the measured amounts of water is indicative of a water uptake by the plant. The transpiration and retention of water by the plant can be determined accordingly therefrom.

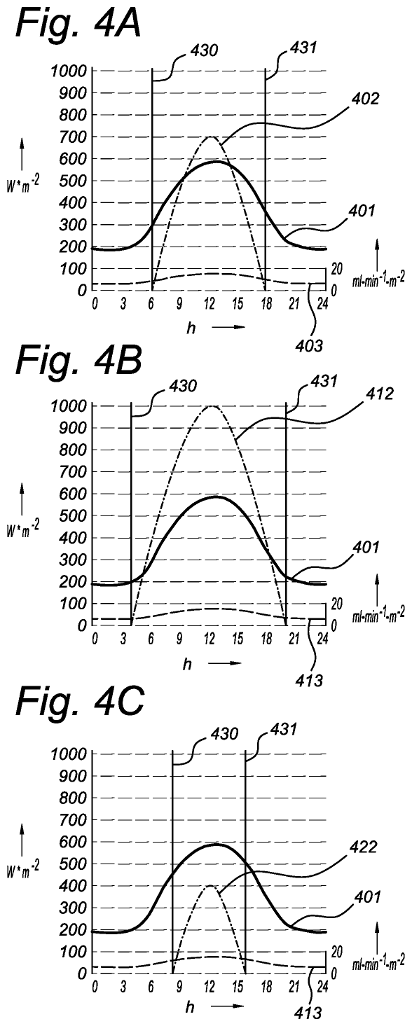

In another exemplary method, the amount of water supplied to a plant is measured as well as a change in weight of the plant and substrate. These measurements can be used to determine a transpiration of the plant. The water uptake and water retention can accordingly be determined therefrom. Here the plant may be a reference plant. In yet another exemplary method, a time interval is measured between the time at which water is supplied to a plant and a time at which water drainage from the plant is observed to occur at a drainage point. This time interval can be used to determine water uptake by the plant. Retention and transpiration can accordingly be determined therefrom. FIGS. 4A-4C illustrate what would happen if the curve 401 for controlling the window 13 remains the same during spring (FIG. 4A), summer (FIG. 4B) and winter (FIG. 4C), while the corresponding lines 402, 412, 422 indicate energy of sunlight incident, in W*m⁻², on the plants are different. According to the invention the water flow to the plants may be controlled based on the curve 401. If this curve 401 is the same in spring, summer and winter, then respective rates of transpiration 402,412, 422 in spring summer and winter will be substantially the same as well. However, due to the differences in amount energy of sunlight on the plants, the amount of dry weight of plants produced during the seasons will differ, resulting in plants having a dry-weight percentage that is highest in the summer and lowest in the winter. The present invention makes it possible to steer for a constant amount of dry-weight of the plants in all seasons, by compressing or stretching the predetermined curve 401 based on the expected amount of energy that will be incident on the plants. For instance, the curve 401 may be stretched or compressed with respect to the time axis based on the distance between lines 430 and 431 which indicate a duration time between which sunlight is incident on the plants. Stretching or compressing of the predetermined curve 401 with respect to the vertical axis can be done based on the position of the peak of the curve 402, 412 or 422

Thus, constant quality plants can be grown in all seasons. The amount of energy that is expected to be incident on the plants is proportional to the position of the sun and can be looked up for any longitude and latitude where the method is to be carried out.

Alternatively, if so desired by the grower, the curves can be adjusted to steer for a constant water uptake by the plants in all seasons, though with varying dry-mass content of the plants. Thus, the yield in total weight of the plants can be controlled to be substantially constant between seasons.

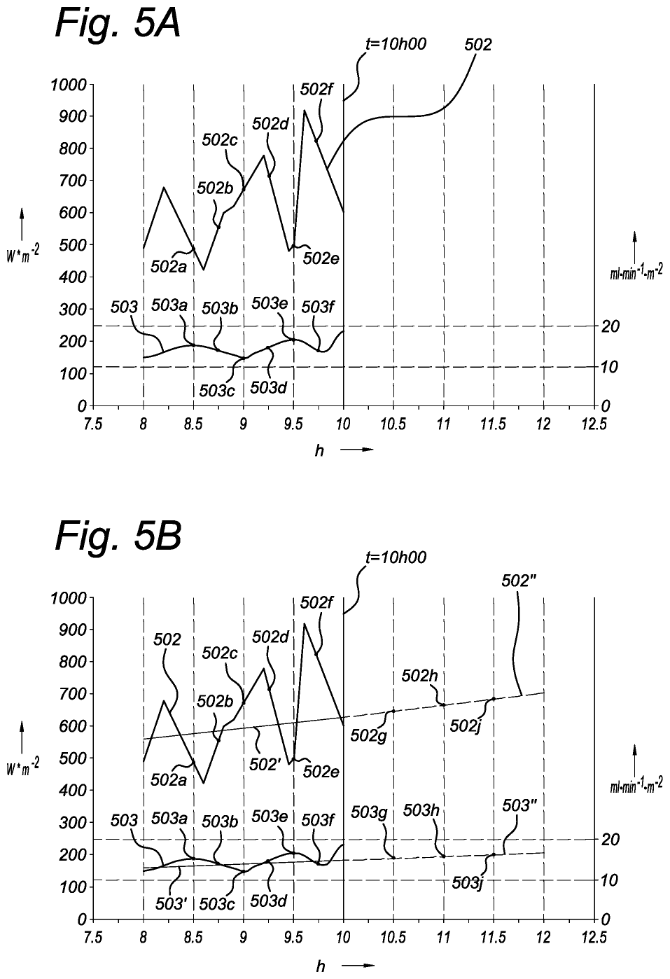

FIGS. 5A and 5B illustrate how the method of the invention may be carried out. FIG. 5A shows a graph 502 of solar energy incident on the plants over time, measured in Watt per m 2 of plants, as indicated by the vertical left hand side scale, for instance using an actinometer or pyranometer. The measured indication of the solar energy incident on the plants forms a first flow parameter which represents a flow of energy to the plants. The solar energy is just one of a number of flow parameters for the plants that are indicative of a subsequent transpiration and/or water uptake by the plants. In general, an increase in the amount solar the solar energy incident on the plants will result subsequent in a higher transpiration and/or water uptake by the plants, and a decrease in the amount of solar energy incident on the plants will result in a subsequent lower transpiration and/or water uptake by the plants. Other flow parameters that are indicative for a subsequent (i.e. somewhat delayed) transpiration and/or water uptake by the plants include: a flow of air along the plants, a flow of CO₂ to the plants to be absorbed, and a flow of water to the plants and/or through a substrate holding the roots of the plants.

FIG. 5A further shows a graph 503 of water uptake by the plants over time. The water uptake may be determined as the total amount of water supplied to the plants minus the total amount of water drained from the substrate or the like in which the plants are grown. Here, the water uptake is measured in ml*min⁻¹*m⁻², as indicated by the vertical right hand side scale. When the plants are located in a greenhouse, both the amount of water supplied to the plants and the amount of water drained from the substrate or the like in which the plants are grown, can typically easily be measured. When the plants are located outside in a field, an indication of the water uptake by the plants in the field may be obtained using a potted reference plant and measuring the water supply to the potted reference plant and determining the change in weight of the plant pot, plant and substrate in the pot over time. As the pot substantially prevents water from draining out of the pot any change in weight will substantially correspond to the weight of water that the plant has transpired through its leaves. Other methods of obtaining an indication of transpiration by the plants, either in an open field or in a greenhouse, will be apparent to the skilled person. Regardless of how it is measured or calculated, the measured water uptake forms a second flow parameter that is indicative of the water uptake by the plants, and there is generally a delay between a change in water uptake by the plants and a corresponding change in transpiration by the plants.

In accordance with the method, at a current time t, several measurements 502a-502f, and 503a-503f indicative respectively of the transpiration and water uptake by the plants are obtained for several points in time that all are prior to 90 minutes of the current time t. In the present example the current time t=10 h00. The measurements together indicate a change in transpiration and water uptake by the plants over time. In the example shown, the measurements 502a-502f for the first flow parameter and the measurements 503a-503f for the second flow parameter were made at substantially the same points in time, i.e. at 8 h30, 8 h45, 9 h00, 9 h15, 9 h30 and 9 h45. However, this is not required for the method to work, and the measurements for the second flow parameter could instead have been made for instance 5 minutes after the corresponding measurements for the first flow parameter.

As can be seen in FIG. 5A, the changes in gradient of graph 503, that is indicative of the water uptake by the plants, substantially follows the graphs 502 that is indicative of light incident on the plants, though with a delay. The duration of the delay can be determined in several ways, e.g. by determining how much graph 502 should be shifted in time for the peaks and valleys in the graph 502 to be located at substantially same points in time as corresponding peaks and valleys in the graph 503. Other methods for determining the delay, which may include comparing 1st and/or 2nd derivative approximations of the graphs 502, 503, will be apparent to the skilled person. In particular, if a sufficient number of measurements is obtained, the delay may be based on the measurements that are indicative of the changes in the first and second flow parameters over time. In the present example, the change in water uptake lags behind a corresponding change in transpiration by about 15 minutes, so that that when there is a peak or valley in line 502, a corresponding peak or valley in line 503 will be present about 15 minutes later. FIG. 5A shows graphs of the first and second flow parameter when the method has not yet been used to compensate for such a delay.

FIG. 5B shows that, based on measurements obtained in the period of time at least 90 minutes prior to the current time t=10 h00, a line of best fit 502′ is calculated for said period of time. Next, the line 502′ is linearly extrapolated to line 502″ for future points in time after the current time t=10 h00. The line 502′ shown was calculated by fitting the measurements 502a-502f to a straight line using a least squares method. As the delay between change in energy incident on the plants and a corresponding change in water uptake is known, it is possible to predict corresponding a change in the water uptake 503g-503j for future points in time based on the line 502″ and by compensating for the known delay of about 15 minutes.

Additionally or alternatively, a line 503′ may be calculated by fitting the measurements 503a-503f to a straight line using a least squares method, and based on line 503′ a line 503″ can be linearly extrapolated for future points 503g-503j in time after the current time t=10 h00 to predict a change in water uptake by the plants. Of course, other methods which allow values and changes of the first and second measurements to be extrapolated to future points in time could be used instead.

Next, based on these predictions, the flow of water to the plants is controlled, taking into account that a change in transpiration by the plants will generally occur 15 minutes earlier before the plants need a corresponding change in water supply. For instance, if the prediction is that a change in the transpiration by the plants will change from increasing transpiration to decreasing transpiration at a future point in time at 11 h25, then the supply of water to the plants can be controlled at said time 1 h25 minus the delay time, i.e. minus 15 minutes, to change from an increase in the water supply to a decrease as well. This would mean that the water supply is controlled at 11 h10 to decrease. In this manner the method of the invention takes the delay is between a change in transpiration by the plants and a corresponding change in the water uptake by the plants and taken into account.

The method is particularly suitable to be carried out in a greenhouse where both the water supply to the plants and the transpiration by the plants can be controlled to some extent, the first simply by changing a degree to which a water supply valve for supplying water to the plants is opened, and the second for instance by changing the degree to which a window of the greenhouse is opened and/or by changing the amount of sunlight that is incident on the plants. In such a case, instead of adjusting the water supply to the plants, the degree of opening of the window could be changed, and/or an adjustable shade could be controlled to prevent sunlight from being incident on the plants to a controllable extent. Combinations of these could also be used, depending on the needs of the grower. For instance, if water is scarce, the water supply may be controlled to change only smoothly over time, e.g. substantially following a circadian curve for the plants, and using the method, other environmental factors which affect transpiration by the plants can be controlled taking into account a future change of the water supply.

Though the method is preferably carried out in a greenhouse, instead it may be carried out in an open field where plants are grown. In such an open field, the main parameter for the plants that can be controlled by a grower is water supply to the plants. The method allows the water supply to the plants to be controlled such that it changes in a smooth matter, rather than rapidly, e.g. by measuring a flow parameter that is indicative of water uptake by the plants at a future point in time. For instance, in a field, a parameter indicative of light incident on the plants can be measured, and based thereon a change in transpiration of water by the plants at future points in time can be predicted. Based on the prediction, the water supply can then be controlled in a manner in which a delay of between 5 to 30 between the time a change in light incident on the plants is measured, and a subsequent change in water uptake by the plants occurs is compensated for.

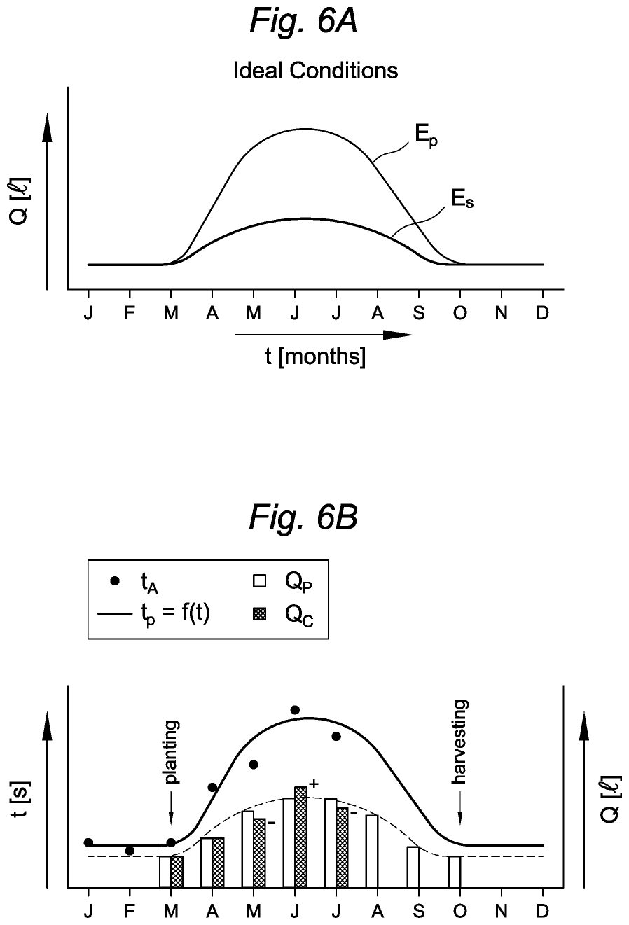

FIGS. 6A and 6B illustrate how the method of the invention may be carried out in an open field. FIGS. 6A and 6B particularly illustrate an example of open field cultivation of potato plants in soil, e.g. clay, in the open field. In FIG. 6A curve Ep denotes the transpiration of a potato plant as a function of time during a grow season from April to October, under ideal growing conditions. Curve Es denotes the transpiration of the open field in absence of any potato plant as a function of time. Said function can be determined experimentally and/or theoretically, for example using a reference field or in a laboratory setting. The functions Ep, Es may be adapted to the particular climatologic and geographic circumstances at the open field where the potato plants are to be cultivated. It can be seen that the potato plant transpiration has a maximum in July, corresponding to the summer season on the northern hemisphere. The transpiration of plants can be an indication of a consumption capacity of the plants. Hence based on the transpiration curve of a plant, in this case a potato plant, a consumption capacity of the plant over time can be determined. A high water transpiration rate of the plant, for example, corresponds to a high consumption of water. The functions Ep and Es, can be used to determine an optimal water feed for the potato plants over time, adapted to the time varying water consumption capacity of the potato plant.

FIG. 6B illustrates the cultivation of the potato plants during the growth season. FIG. 6B particularly shows at time delay between a moment of water supply to the plant, and a moment of water drainage from the plant occurring at water drainage of the open field. Said time delay in this example forms an indication of a consumption of water by the potato plants. A large time delay, for example, indicates a high uptake of water from the soil, and thus a high consumption of water by the plant.

A function of the time delay over time under optimal circumstances can be determined based on the transpiration model of FIG. 6A. Said function of time delay, for ideal conditions, is indicated by curve tp. To optimise growth and development of the potato plants, it is an object to provide the potato plants in the open field with water in such quantities that the actual time delay measured in the open field tracks or preferably even surpasses the reference curve tp. The measurements of the actual time delay are indicated by ta in FIG. 6B.

It can be seen from the actual measurements ta that in January, February and March, the open field has been watered, in the absence of any potato plants, to gather information about the drainage characteristic of the soil of the open field. In April, the potato plants are sown in the open field, wherein an initial quantity of water is fed to the potato plants based on the model of FIG. 6A. The potato plants are watered for example once a month. The amount of water fed to the potato plants each month is indicated by the bar Qc.

The water feed to the plants is for example controlled by a control apparatus, that e.g. is arranged to control one or more valves for opening and closing one or more water conduits of an irrigation system. The controller may operate the one or more valves based on control data indicating the quantity of water to be fed to the plants, or a change in the quantity of water to be fed to the plants.

From April on, the potato plants grow and extract some of the supplied water from the soil and consume the extracted water. The uptake of water by the plant is visible by the measurements ta as a the time delay between watering and drainage.

At a given moment, when the potato plants are watered, the quantity of water that is fed to the potato plant is based on a prediction of a capacity of consumption of the potato plant using a function, such as Ep, Es, tp, wherein the quantity of water is compensated for a difference between an indication of real consumption in the past and a theoretical capacity of consumption of the potato plants.

For example, when feeding water to the potato plants at a given time in May, the quantity of water to be fed to the plants is determined based on a prediction of the water consumption capacity in the future. The prediction is based on curve tp, indicating that the consumption capacity is expected to increase with a certain amount. The predicted quantity of water that is to be supplied based on the model tp, is indicated by the left bar Qp. However, it is also observed from an earlier measurement ta of the actual time delay, that the actual consumption of the potato plant is slightly below the reference curve tp. Accordingly, the quantity of water to be fed to the potato plants at the given time in May is compensated for this difference. In this case, the corrected quantity of water that is fed to the potato plant at the given time in May, is less than the predicted quantity.

The present invention has been described above with reference to a number of exemplary embodiments as shown in the drawings. Modifications and alternative implementations of some parts or elements are possible and are included in the scope of protection as defined in the appended claims.

The disclosure will now be further described by the following numbered Embodiments which are to be read in connection with the preceding paragraphs and which do not limit the disclosure. The features and preferences as described hereinabove apply also to the following Embodiments.
Embodiment 1A. Method of cultivating plants, comprising the steps of:
obtaining measurements (502a-502f; 503a-5030 which indicate a change in one or more flow parameters of the plants over a period of time within 90 minutes prior to a current point in time (t), the flow parameters being indicative of transpiration by the plants, and/or water uptake by the plants;
predicting a change in water uptake and/or water transpiration by the plants at one or more future points in time (502″g-502″j; 503″g-503″j) which are ahead of the current point in time, based on the measured indication of change of the one or more flow parameters; and
prior to said one or more future points in time:
controlling one or more of: flow of water to the plants, flow of CO₂ to the plants and/or light incident on the plants, based on the predicted change in water uptake by the plants and/or water transpiration by the plants at the one or more future points in time and substantially compensating for a delay of between 5 to 30 minutes between a change in transpiration by the plants and a corresponding change in water uptake by the plants.
   Embodiment 1B. Method of cultivating plants, comprising the steps of:
obtaining measurements (502a-502f; 503a-5030 which indicate a change in one or more flow parameters of the plants over a period of time within 90 minutes prior to a current point in time (t), the flow parameters being indicative of transpiration by the plants, and/or water uptake by the plants, wherein the flow parameters include one of more of: air flow along the plants which affects transpiration by the plants, water flow to and/or through the plants which affects water uptake by the plants, and light energy incident on the plants which affects the transpiration by the plants;
predicting a change in water uptake and/or water transpiration by the plants at one or more future points in time (502″g-502″j; 503″g-503″j) which are ahead of the current point in time, based on the measurements which indicate the change of the one or more flow parameters; and
characterized in that the method comprises, prior to said one or more future points in time:
   controlling one or more of: flow of water to the plants, flow of CO₂ to the plants and/or light incident on the plants, based on the predicted change in water uptake by the plants and/or water transpiration by the plants at the one or more future points in time and substantially compensating for a delay between a change in transpiration by the plants and a corresponding change in water uptake by the plants, wherein said delay is between 5 to 30 minutes.
   Embodiment 2. Method according to Embodiment 1, wherein said step of obtaining measurements comprises obtaining, over said period of time within 90 minutes prior to the current point in time, first measurements which indicate a change in a first flow parameter indicative of transpiration by the plants, and second measurements which indicate a change in a second flow parameter indicative of water uptake by the plants; and wherein said delay is determined by comparing the first measurements with the second measurements and determining by how much a change in the first flow parameters lags to a change in the second flow parameters.
   Embodiment 3. Method according to Embodiment 1 or 2, wherein the delay is a predetermined delay that has been determined prior to carrying out the method.
   Embodiment 4. Method according to Embodiment 1, 2 or 3, wherein, in said step of controlling, at least the flow of water to the plants is controlled based on the predicted change in water uptake by the plants and/or water transpiration by the plants at the one or more future points in time while substantially compensating for the delay between the change in transpiration by the plants and the corresponding change in water uptake by the plants.
   Embodiment 5. Method according to any one of the preceding Embodiments, wherein the flow of water to the plants is controlled in such a manner that, at the one or more future points in time, a rate of transpiration by plants is within +-5% of a rate of water uptake by the plants.
   Embodiment 6. Method according to any one of the preceding Embodiments, wherein the change in water uptake and/or water transpiration by the plants for the one or more future points in time is predicted further based on a predetermined continuous smooth curve which spans a period of time of at least 8 hours, preferably at least 12 or at least 24 hours, and which includes the one or more future points in time.
   Embodiment 7. Method according to Embodiment 6, wherein the predetermined curve is a curve which, at any position, deviates no more than +-5% from a non-linear spline having between 8 and 3 control points, preferably a non-linear spline having 5 or 4 control points.
   Embodiment 8. Method according to Embodiment 7, wherein the spline has at most one point of inflexion in each time period of the curve spanning 2 hours, preferably 3 hours.
   Embodiment 9. Method according to any one of Embodiments 6-8, wherein the predetermined curve represents a predetermined circadian rhythm of the plants over said at least 8 hours, preferably at least 12 or at least 24 hours, wherein said at least 8 hours include a time period of at least 4 hours during which the plants are in the dark.
   Embodiment 10. Method according to Embodiment 9, wherein said step of obtaining measurements comprises obtaining at least three such measurements, and wherein the delay to compensate for when controlling said flow of water to the plants, flow of CO₂ to the plants and/or light incident on the plants is calculated based on where the three measurements match with the curve.
   Embodiment 11. Method according to Embodiment 10, wherein the predetermined curve represents a circadian rhythm of the plants for one or more of: uptake and release of CO₂ by the plants, uptake of water by the plants and transpiration of water by the plants, and/or generation of sugar by the plants.
   Embodiment 12. Method according to any one of Embodiments 6-11, wherein the curve, at least during a duration of time during which the light energy incident on the plants is 30 Watt/m² or greater, substantially corresponds to a polynomial function of time, wherein polynomial function is of the 4th or greater degree
   Embodiment 13. Method according to any one of Embodiments 6-12, wherein the duration of the delay varies over said time period of at least 8 hours, preferably wherein said duration of the delay varies by at least 5 minutes within said time period of at least 4 hours in which the plants are not in the dark.
   Embodiment 14. Method according to any one of the preceding Embodiments, carried out in a greenhouse having an interior space for cultivating plants.
   Embodiment 15. Method according to Embodiment 14, wherein the flow of water to the plants is controlled substantially independent of a measured temperature of the air in the interior space as long as the measured temperature of the plants is in the range of 4,0 to 41,6° C. measured at 1 atm.
   Embodiment 16. Method according to Embodiment 14 or 15, wherein the air humidity in the interior space is controlled to be at least 5 g water per kg of air, and/or the CO₂ concentration of the air in the interior space is controlled to be above 185 ppm.
   Embodiment 17. Method according to Embodiment 8, further comprising a prior step of measuring an estimate of the circadian rhythm of the plants during a time period of at least 24 hours and generating the predetermined curve from said estimate.
   Embodiment 18. A system comprising:
a greenhouse for cultivation of plants, comprising a housing which defines an interior space, and one or more climate control devices for controlling one or more of: temperature, CO₂ concentration and/or humidity of the air in the interior space and supply of water to the plants; and
a control apparatus, connected to said one or more climate control devices and configured for controlling said climate control devices according to the method according to any one of claims 1-17.
   Embodiment 19. Computer readable medium provided with instructions thereon, which, when executed by a computer, cause the computer to carry out the method according to any one of Embodiments 1-17.
   Embodiment 20. A method of cultivating plants, comprising the steps of:

based on measurements that are indicative of a previous change in transpiration by the plants and/or based on measurements that are indicative of a previous change in water uptake by the plants, predicting a change in water uptake and/or water transpiration by the plants at one or more future points in time which are ahead of the current point in time; and prior to the one or more future points in time: controlling one or more of: flow of water to the plants, flow of CO₂ to the plants and/or light incident on the plants, based on a predetermined smooth curve and/or and the predicted change in water uptake or water transpiration by the plants, in such a manner that a delay of between 5 to 30 minutes between a change in water uptake and a corresponding change in transpiration by the plants is substantially compensated for. Thus, the method takes into account the delay of between 5 and 30 minutes there is from the moment the flow of water or CO₂ and or light incident on the plants is controlled, to the moment the plants have correspondingly adjusted their water uptake and transpiration.

1. A method of cultivating plants in which a quantity of one or more consumables that is fed to the plants at a given time is controlled based on a prediction of a capacity of consumption of said plants at a time in the future relative to the given time using a function of capacity of consumption for said plants that varies over time, and is compensated for a difference between an indication of real consumption of said plants at a time in the past relative to the given time and a theoretical capacity of consumption of said plants determined for said time in the past using said function.

2. The method of claim 1, in which said given time accounts for a time delay between a time of feeding consumables to the plants and consumption of said consumables by said plants at said future point in time.

3. The method of claim 1, in which said function of capacity of consumption for said plants includes at least one cyclic component, in particular a circadian cycle component for said plants, a growth cycle component for said plants and/or developmental cycle component for said plant.

4. The method according to claim 1, in which consumption of said plants is expressed using at least one water related parameter of said plant, in particular water evaporation, water take up, water retention, a water balance and/or water drain for said plants and/or its substrate.

5. The method of claim 1, in which said indication of real consumption of said plants includes a determination of at least one water related parameter of the plant, from the group consisting of water evaporation, water take up, water retention, a water balance and/or water drain for said plants and/or a substrate that the plants are cultivated on.

6. The method of claim 1, in which the one or more consumables include water.

7. The method of claim 1, in which the one or more consumables are water, or water enriched with nutrients.

8. The method of claim 1, in which the plants are cultivated in an open field.

9. The method of claim 1, in which a substrate that the plants are cultivated on comprises soil.

10. The method of claim 1, comprising the steps of:
obtaining measurements which indicate a change in one or more flow parameters of the plants over a period of time within 90 minutes prior to a current point in time, the flow parameters being indicative of transpiration by the plants, and/or water uptake by the plants;
predicting a change in water uptake and/or water transpiration by the plants at one or more future points in time which are ahead of the current point in time, based on the measured indication of change of the one or more flow parameters; and
prior to said one or more future points in time:
controlling one or more of: flow of water to the plants, flow of CO₂ to the plants and/or light incident on the plants, based on the predicted change in water uptake by the plants and/or water transpiration by the plants at the one or more future points in time and substantially compensating for a delay of between 5 to 30 minutes between a change in transpiration by the plants and a corresponding change in water uptake by the plants.

11. The method of claim 1, comprising the steps of:
based on measurements that are indicative of a previous change in transpiration by the plants and/or based on measurements that are indicative of a previous change in water uptake by the plants, predicting a change in water uptake and/or water transpiration by the plants at one or more future points in time which are ahead of the current point in time; and prior to the one or more future points in time: controlling one or more of: flow of water to the plants, flow of CO₂ to the plants and/or light incident on the plants, based on a predetermined smooth curve and/or and the predicted change in water uptake or water transpiration by the plants, in such a manner that a delay of between 5 to 30 minutes between a change in water uptake and a corresponding change in transpiration by the plants is substantially compensated for.

12. A system comprising a greenhouse or open field for cultivation of plants, comprising one or more consumable feed devices for feeding one or more consumables to the plants, and a control apparatus connected to said one or more consumable feed devices and configured for controlling said one or more consumable feed devices according to a method of claim 1.

13. The system according to claim 12, comprising greenhouse for cultivation of plants, the greenhouse comprising a housing which defines an interior space, and one or more climate control devices for controlling one or more of: temperature, CO₂ concentration and/or humidity of the air in the interior space and supply of water to the plants; wherein the control apparatus is connected to said one or more climate control devices and configured for controlling said climate control devices according a method of claim 1.

14. A computer readable medium provided with instructions thereon, which, when executed by a computer, cause the computer to carry out the method according to claim 1.

15-18. (canceled)
